(19) United States
(12) Patent Application Publication
(10) Pub. No.: US 2003/0140938 A1
(43) Pub. Date: Jul. 31, 2003

(54) Dental floss display dispenser

(76) Inventors: Dawn R. Evans, Manhattan Beach, CA (US); Jeanne M. Smith, Houston, TX (US)

Correspondence Address: William D Durkee, Howrey Simon Arnold & White, 750 Bering Drive, Houston, TX, 77057-2198, US

(21) Appl. No.: 10/258,075

(22) PCT Filed: Apr. 19, 2001
(86) PCT No.: PCT/US01/40556

(51) Int. Cl. A61C 15/00

(52) U.S. Cl. 132/325

(57) ABSTRACT

A dental floss dispenser for displaying a graphic, such as a cartoon face, to induce use of floss comprises a housing (12) which displays an enticing graphic, a floss cutter (30) located in association with the enticing graphic, and a back (24) for the housing (12) to form a receptacle (28). The dispenser includes an outlet for a strand of floss (26) to escape the receptacle (28) and be pulled to the floss cutter (30) and a fastener (36) associated with the dispenser for attaching the dispenser to a separate object such as a mirror, wall or cabinet in a bathroom.

This application claims the benefit of provisional applications serial Nos. 60/198,291 filed Apr. 19, 2000; 60/211,509 filed Jun. 14, 2000; and 60/227,977 filed Aug. 25, 2000.

The invention relates to a dental floss dispenser which is convenient and which displays an appearance for enticing use of dental floss, including particularly use of floss by children.

### BACKGROUND OF THE INVENTION

Regular use of dental floss is recommended as an aid to healthy gums and teeth, both for adults and children. Many people, however, do not floss regularly because the floss is forgotten when it is in a drawer or cabinet somewhere, or time does not allow for finding the floss even if remembered. Thus, a display dispenser is needed to remind a person to floss and to make use of floss convenient.

### SUMMARY OF THE INVENTION

A dental floss display dispenser in accordance with the invention comprises a display housing for a spool or roll of dental floss which is shaped to have an enticing appearance.

The display housing has a back to close the housing or to form a receptacle for a spool of floss. The display housing has an exposed floss cutter and the floss passes out of the housing to the floss cutter for cutting a suitable length of floss for flossing.

The back preferably has associated with it a fastener for attaching the display dispenser to a surface or other object in a bathroom, kitchen, or other location such as a mirror, wall, counter top, tile, or cabinet. The fastener may be adhesive tape, hook and loop, molded or drilled holes for nails or screws, a loop, etc.

The display housing is preferably made of plastic and molded to a shape resembling enticing characters, toys, or graphics, including holographics, which catch attention and act as a reminder to floss.

The housing can also include one or more holders for a toothbrush and toothpaste.

### BRIEF DESCRIPTION OF THE DRAWINGS

FIG. 1 is a front view of a floss dispenser in accordance with the invention showing a commercial floss dispenser located behind the front face.

FIG. 2A is a front view of the floss dispenser of FIG. 1.

FIG. 2B is an enlarged portion of the dispenser of FIG. 2A.

FIG. 2C is a side view of the dispenser of FIG. 1 showing the commercial floss dispenser in place.

FIG. 3 is another embodiment of a floss dispenser in accordance with the invention.

FIG. 3A is an enlarged view showing the floss cutter in FIG. 3.

FIG. 4 is a view in elevation of a metal floss cutter.

FIG. 5 is a front view of another embodiment of a floss dispenser in accordance with invention.

FIG. 6A is a front view of another embodiment of a floss dispenser in accordance with the invention, which includes a holder for a toothbrush.

FIG. 6B is a side view of a floss dispenser of FIG. 6A.

FIG. 6C is another side view of the floss dispenser of FIG. 6A.

FIG. 6D is a side view of the floss dispenser of FIG. 6A showing the dispenser in an open position.

FIG. 7 is a front view of another embodiment of a floss dispenser in accordance with the invention.

FIG. 8 is a rear view of the floss dispenser of FIG. 7.

FIG. 9 is a side view of the floss dispenser of FIG. 7.

FIG. 10 is a sectional view taken along the line 10-10 in FIG. 9.

FIG. 11 is a side view of the dispenser of FIG. 7 showing the dispenser in an open position.

### DETAILED DESCRIPTION OF THE INVENTION

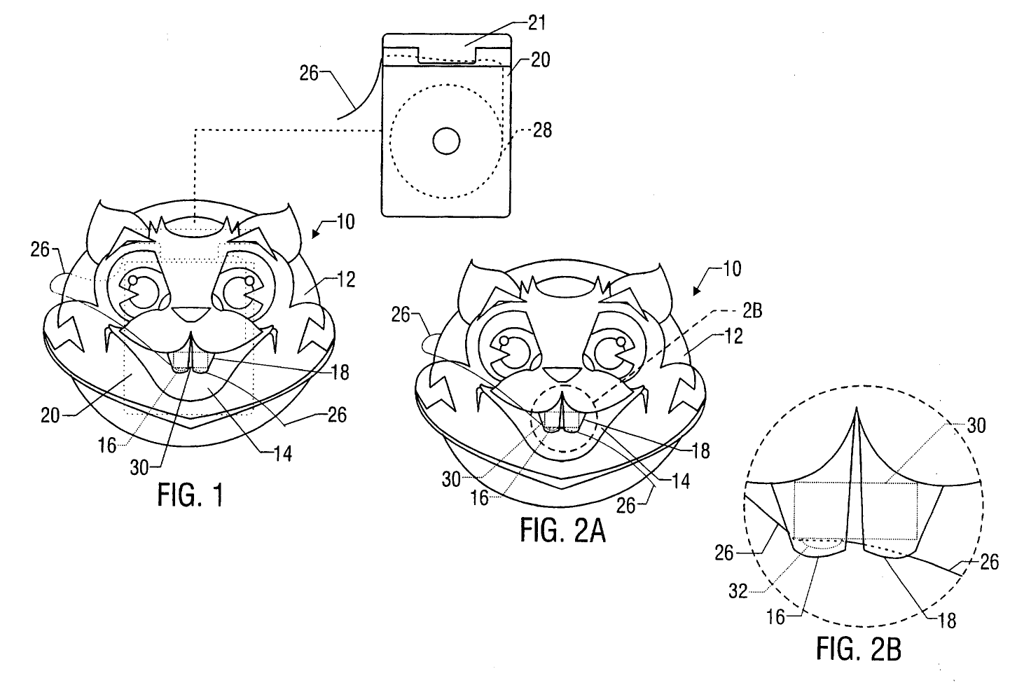

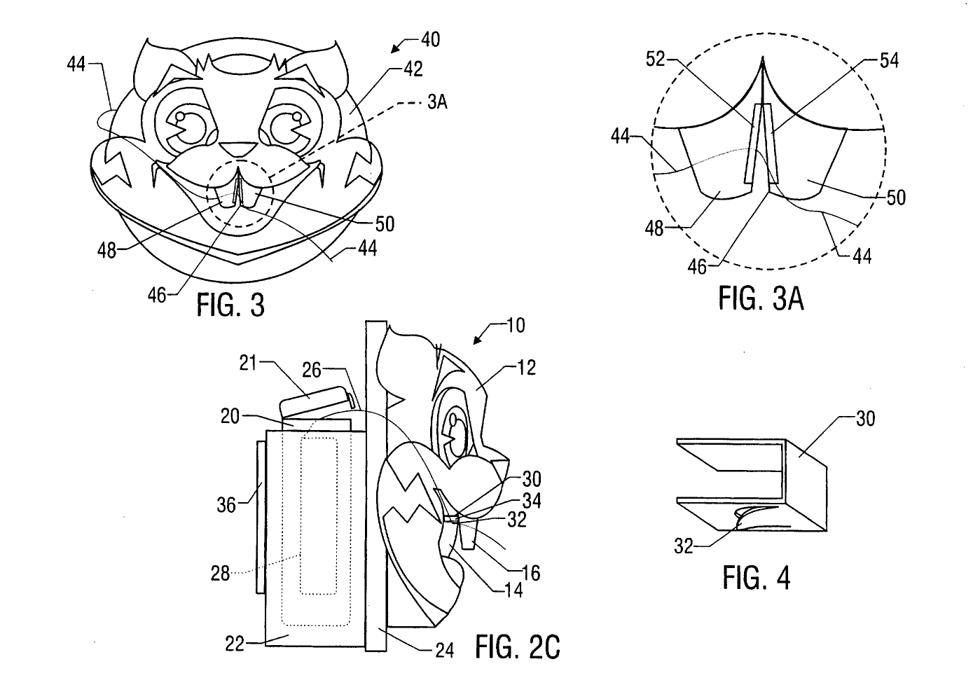

With reference to FIG. 1, FIG. 2A and FIG. 2C, a dental floss dispenser 10 has a front housing 12 which is molded plastic in the shape of a cartoon face with facial features of a bear, cat or beaver. The housing 12, which may be molded to be hollow, has a recessed mouth 14 with teeth 16 and 18 protruding downwardly from the top of the mouth 14 and in front of the mouth 14.

A commercially available floss dispenser 20, with its lid 21 open, fits in a floss receptacle 22 attached by molding or glue to the back 24 of the housing 12. The back 24 may be molded with the housing 12 or may be glued to it. A floss strand 26 from the floss roll 28 passes out of the dispenser 20 and around the front of the housing 12 to near the teeth 16 and 18.

The strand 26 engages a floss cutter 30 located behind the teeth 16 and 18. Floss cutter 30, which is shown in FIG. 4, is a U-shaped, metal spring clamp having a cutting edge 32 on its lower leg for cutting floss strand 26. Floss cutter 30 fits on a projection 34 behind teeth 16 and 18. Projection 34 can have raised edges or borders to help hold cutter 30 in place. Alternatively, cutter 30 can be glued in place with or without the projection 34.

On the rear side of back 24 with receptacle 28 is a fastener 36, such as an adhesive pad or tape, which can fasten the dispenser 10 to a suitable surface as a convenient reminder to use dental floss regularly.

FIGS. 3 and 3A show the same embodiment as in the prior figures, but a different cutting mechanism is shown. In this embodiment, dispenser 40 has a housing 42 and a floss strand 44 passing through a notch 46 between the front teeth 48 and 50. The teeth 48 and 50 on opposite sides of the notch 46 contain cutting edges 52 and 54 for cutting floss strand 44. All other parts are similar to those in FIGS. 1, 2A. 2B and 2C.

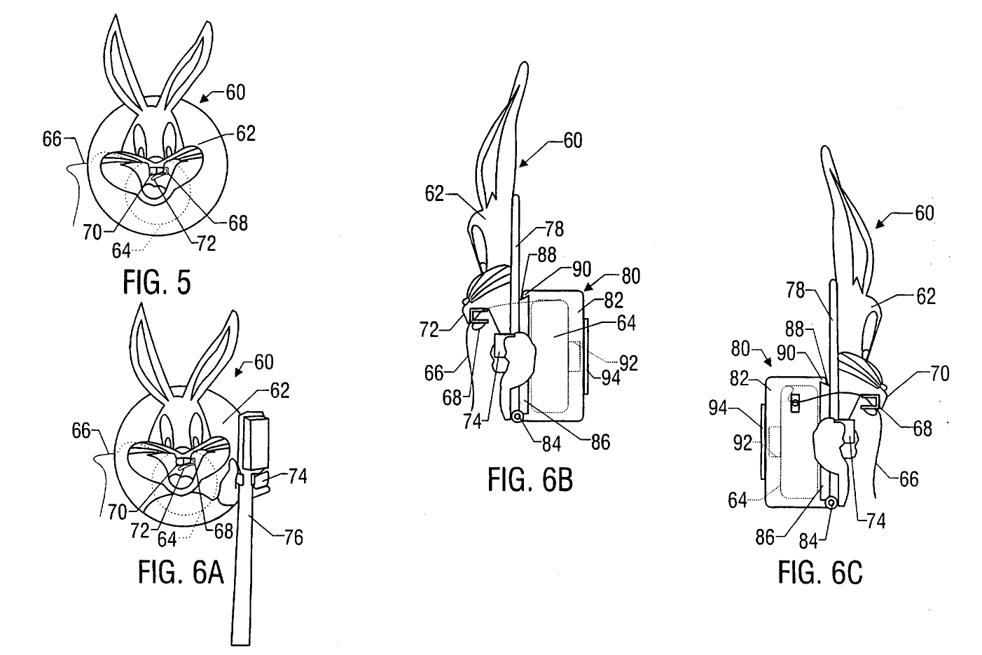

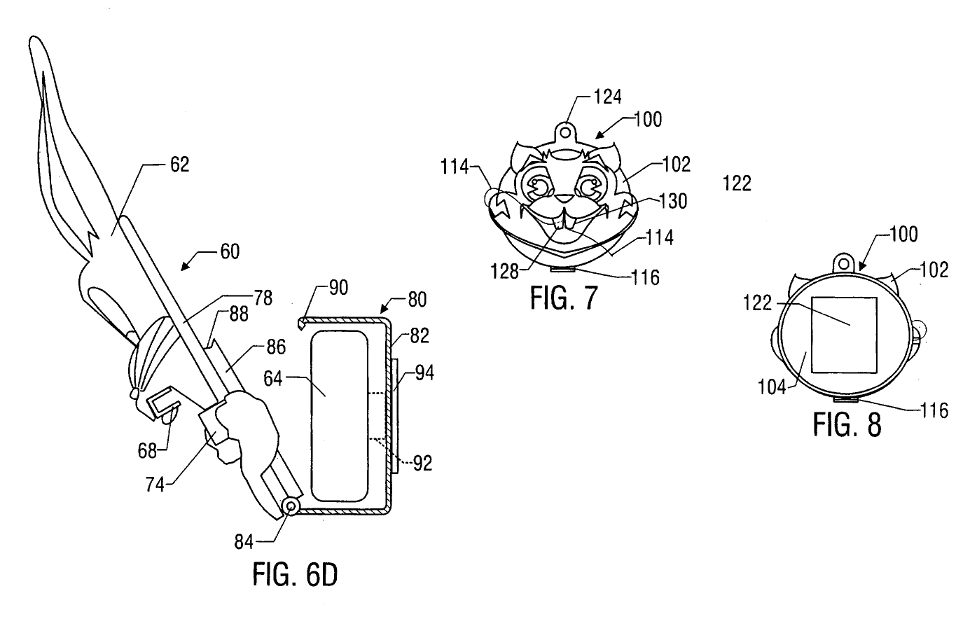

The embodiment of FIG. 5 illustrates a floss dispenser 60 which has a decorative housing 62 displaying a cartoon rabbit. Floss roll 64 has floss strand 66 passing from it. A metal floss cutter 68 is glued behind the front teeth 70 and 72. The embodiment of FIG. 5 is the same as the embodiment in FIGS. 6A to 6D except the latter embodiment includes a holder 74 for a toothbrush 76. All other parts are the same and are referred to with the same reference numerals.

As shown in FIGS. 6B, 6C and 6D, the floss dispenser 60 has a housing 62 displaying a cartoon rabbit for its enticing graphics. Housing 62 has a back 78 molded or glued to it. Back 78 includes a floss receptacle 80 which comprises a cover 82 which is hinged at hinge 84 to both the housing 62 and the back 78. The cover 82 snaps over a side closure 86 molded or glued to be a part of back 78. Side closure 86 has a depression 88 which mates with projection 90 to hold along with hinge 84 the receptacle 80 closed when the cover 82 and closure 86 are snapped together.

Metal floss cutter 68 is glued to the housing 62 behind the teeth 70 and 72. Floss roll 64 fits rotatably over a pin 92 attached to cover 82. Adhesive pad 94 is attached to the back of cover 82 to attach the dispenser 60 to a flat surface, such as a surface in a bathroom.

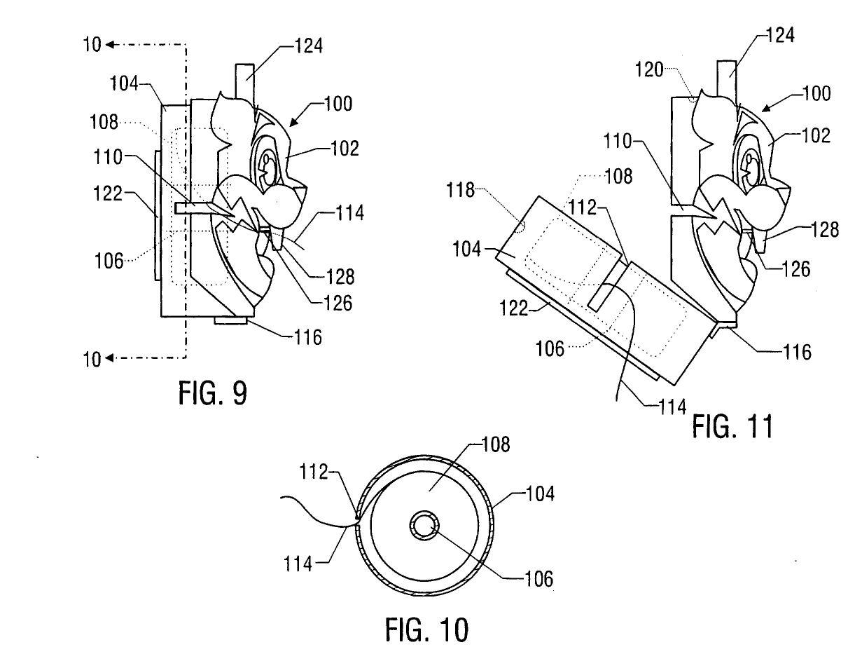

With reference to FIGS. 7 to 11, a dental floss dispenser 100 has a housing 102 which displays a graphical cartoon figure. A back 104 is hollow with a pin 106 for receiving rotatably a floss roll 108. A floss outlet 110 in the housing 102 corresponds with a floss outlet 112 in the back 104 to allow a floss strand 114 to escape from the interior of the dispenser 100.

Back 104 is connected to the housing 102 by a flexible plastic hinge 116 at the bottom of the dispenser 100 to allow opening for insertion of the floss roll 108. The back 104 has a depression 118 which mates with projection 120 to stop and hold the back 104 securely to the housing 102. Adhesive pad 122, which is affixed to the rear of back 104, can fasten the dispenser 100 to a flat surface securely. Alternatively, a loop 124 can be provided for attachment of the dispenser 100 to another object, such as a key chain, metal clasp, or lanyard, particularly when the dispenser is small to promote portability for use during the day. Metal floss cutter 126 is fixed to the housing 102 behind the teeth 128 and 130 to cut the floss strand 114.

The foregoing description shows that this product is a mountable, refillable and/or disposable dental floss dispenser/accessory holder (for but not limited to toothbrush and toothpaste) for existing and future commercially available dental floss containers and refillable dental floss spools or bobbins of any size or length. It preferably has an adhesive back, magnetic back, or both which can attach to any surface, thus making the dispenser/accessory holder visible, sturdy and convenient for use. An adhesive back may be two sided tape with a removable non-stick outside cover. Common velcro or hook and loop attachment may also be used. The dispenser can attach to a bathroom wall, cabinet, medicine chest, tile surface, mirror. etc. which would function as a visual reminder to floss daily. In some situations, molded holes or drilled holes for a key chain or lanyard loop, nails, tacks or screws may be used as the fastener.

The housing is preferably manufactured of plastic and molded to any shape resembling popular cartoon characters or character heads or graphics in flat or three dimensional form. It should be considered that although manufacturing the product of plastic materials appears to be the most cost-effective, the dispenser could also be manufactured of wood, metals, ceramic, polymer based materials, silicone, fiberglass or any other appropriate materials.

The dispenser can house existing and future universal manufacturer's floss containers, rolls, or spools. The manufacturer's floss sits behind a 3-dimensional character head or flat graphics face. It is preferred that the housing and its face be molded of plastic as one unit. It should be noted however that the front or 3-dimensional or graphics can be added as a separate unit at the time of manufacturing, and may be attached by means of rivets, screws, glue, etc.

The dispenser can also offer a holder as part of the construction to hold a toothbrush or any other accessory such as toothpaste. The addition of a formed plastic holder for a toothbrush will be comprised of, but not limited to a “C” shaped clip or any other shaped holder capable of holding a toothbrush that nestles into a formed plastic resemblance of a three dimensional character hand or other character appendage or graphic. This holder can be part of the construction of the plastic recessed floss holder and can also be part of the plastic hinged lip construction.

It should be noted that commercially available manufacturer's dental floss containers, rolls, and spools have different sizes and shapes. The dispenser can be designed to accept a particular commercial design, or it may be designed to accept more than one commercially available design. The manufacturer's floss container can be inserted into the dispenser and can be removed when empty. The dispenser may also house a refillable floss spool which opens on a hinge for easy removal and replacement of a floss bobbin, roll, or spool. The dispenser in which the floss bobbin is placed may house a pin or protrusion to hold the floss bobbin.

The user of the dispenser may pull dental floss string to the left of the manufacturer's floss container which is housed within the dispenser. The user of the dispenser may also pull dental floss to the left of the refillable floss spool through a lead, notch or hole in the dispenser construction. At time of use, a user can pull the floss toward the floss cutter preferably located on the 3-dimensional character head or flat graphics face where the mouth or other graphic feature is placed to cut a desired amount of dental floss.

Alternatively, the floss can be located to extend through a hole in the face, mouth, or other flat or 3-dimensional construction to reach the cutting mechanism. Another alternative is a small groove in one side of the face, flat or 3-dimensional frontal feature to feed the floss to the cutting mechanism.

A combination of a hole which feeds a floss receiving groove which in turn feeds the cutting mechanism is a desirable alternative. A combination of holes, or one or more tunnels, which feed the cutting mechanism, may also be employed.

A dispenser for a manufacturer's dental floss container may or may not exceed approximately 3″ in diameter. The floss receptacle should normally be constructed to be approximately 1 ⅝″ wide, 2″ tall, and ¾ to 1″ in depth. However, size may vary as to fit widely sold designs and sizes of existing and future dental floss containers and to accommodate the accessory toothbrush/toothpaste holder if such accessory is molded onto this construction. In the case of a 3-dimensional molded dispenser face or flat basic dispenser, which houses a dental floss spool, the dispenser can range in size from approximately one inch (1″) in diameter to six (6″) in diameter depending on whether or not the unit has the accessory toothbrush/toothpaste holder molded on to it. The dispenser can comprise a variety of shapes and sizes and can accommodate many floss spool sizes and shapes.

The frontal graphics feature and basic construction may be made of but not limited to a common plastic or combination of elements which comprise any plastic of common use, any polymer, ceramic, metal, wood or any durable material. The frontal feature may be manufactured in flat, simple format or construction (other than molded 3-dimensional character representation) upon which flat graphics are printed by many different means on to the frontal feature.

The display dispenser of the invention has been described in relation to preferred embodiments. Modifications will be apparent to persons skilled in the art in view of the invention disclosed herein. For example, the diagram may take the form of a toy or game or part through which is attractive to a user, such as a toy car attractive to children. The cutter could be located on the grill or on the dash, for example. The dispenser can also display the appearance of a desirable doll, or anything else that is attractive to children. The display could also reflect a movie, CD cover, or well known sports or movie stars.

1. A dental floss dispenser for displaying a graphic to induce use of floss, which dispenser comprises:
a) a housing which displays an enticing graphic;
b) a floss cutter located in association with the enticing graphic;
c) a back for the housing to form a floss receptacle;
d) an outlet for a strand of floss to escape the receptacle and be pulled to the floss cutter; and
e) a fastener associated with the dispenser for attaching the dispenser to a separate object.

2. The dispenser of claim 1 in which the graphic is a cartoon face.

3. The dispenser of claim 2 in which the floss cutter is associated with a tooth on the cartoon face.

4. The dispenser of claim 1 in which the graphic is shaped like a toy.

5. The dispenser of claim 1 in which the back forms an upwardly facing floss receptacle for receiving a commercially available floss dispenser.

6. The dispenser of claim 1 in which the back and the housing cooperate to form the floss receptacle and at least one of the back and housing contain a pin for receiving and holding a roll of floss.

7. The dispenser of claim 6 in which the roll of floss is from a commercially available floss dispenser.

8. The dispenser of claim 1 in which the back is connected to the housing by a hinge.

9. The dispenser of claim 1 in which the back and housing have at least one cooperative recess and projection to snap and hold the back and housing together.

10. The dispenser of claim 1 in which the back is connected to the housing by a hinge, the back and housing cooperate to form the floss receptacle, and the back and housing have at least one cooperative recess and projection to snap and hold the back and housing together along with the hinge.

11. The dispenser of claim 10 in which the graphic is a cartoon face.

12. The dispenser of claim 11 in which the floss cutter is associated with a tooth on the cartoon face.

13. The dispenser of claim 12 in which the floss cutter comprises a notch with opposing cutting edges between teeth on the cartoon face.

14. The dispenser of claim 12 in which the floss cutter is a metal cutter attached behind front teeth on the cartoon face.

15. The dispenser of claim 1 in which the housing has a three-dimensional graphic and has hollow space inside, and the back has space on the housing side which cooperates with the housing to form the floss receptacle.

16. The dispenser of claim 1 in which the fastener is adhesive material attached to the back.

17. The dispenser of claim 1 in which the fastener is attached to the back and is a hook and loop fastener.

18. The dispenser of claim 1 in which the fastener is attached to the back and is shaped to fit over the heads of screws and nails.

19. The dispenser of claim 1 in which the fastener is a loop.
